(19) United States
(12) Patent Application Publication
(10) Pub. No.: US 2024/0386811 A1
(43) Pub. Date: Nov. 21, 2024

(54) DATA TRACKING TOY WITH WIRELESS COMMUNICATION AND RELATED METHODS AND SYSTEMS

(71) Applicant: Connor Durrant, Holladay, UT (US)

(72) Inventor: Connor Durrant, Holladay, UT (US)

(21) Appl. No.: 18/319,626

(22) Filed: May 18, 2023

(51) Int. Cl. G09B 19/00; G06F 3/01; G06N 5/022; H04W 4/02

(52) U.S. Cl. CPC G09B 19/00; G06F 3/011; G06N 5/022; H04W 4/02

(57) ABSTRACT

A system of toys may include a first and second toy tracking apparatus and a server. The first and second toy apparatus may each include a processor, a memory, an electronic sensor, and a wireless transceiver. The server may be configured to receive data from at least one of the first toy tracking apparatus or the second toy tracking apparatus where the data is based, at least partially, on sensed measurements by the at least one electronic sensor of the at least one first toy tracking apparatus or the second toy tracking apparatus. The server may also be configured to determine a play time, a play quality score, and a creative play score at least partially responsive to the received data and generate one or more reports based, at least partially, on the determined play time, play quality score, and creative play score.

### TECHNICAL FIELD

This application relates generally to toys and wearable computing devices with electronic sensors to determine movement and physical interaction.

### BACKGROUND

Playing with simple toys helps young children develop physically, intellectually, and socially. Examples of simple toys includes: blocks, cups, and balls. Some toys are designed to function together as a system, such as a set of stackable cups that can be used to build structures or stacked together. Generally speaking, it is desirable to organize toy sets that are intended to function together in a container so they can be used together.

Parents may want to observe how their children's development while playing with such toys and toy sets. However, parents may not be able to watch their children play and to discover what a child is learning and how the child is developing physically, intellectually, and socially based on how they play with the toys.

### BRIEF SUMMARY

Some embodiments of the present disclosure include a system of toys. The system of toys may include a first toy tracking apparatus and a second toy tracking apparatus and a server. Each of the first toy tracking apparatus and the second toy tracking apparatus including at least one processor; at least one memory; at least one electronic sensor; and a wireless transceiver. The server may be configured to receive data from at least one of the first toy tracking apparatus or the second toy tracking apparatus, the data based at least partially on sensed measurements by the at least one electronic sensor of at least one of the first toy tracking apparatus or the second toy tracking apparatus; determine a play time, a play quality score, and a creative play score at least partially responsive to the received data; and generate one or more reports based, at least partially, on the determined play time, play quality score, and creative play score.

Further embodiments of the present disclosure include a method. The method may include collecting data using at least one electronic sensor embedded within one or more toys, transmitting the collected data wirelessly to a remote server, and determining a play time, a play creativity score, and a play quality score at least partially responsive to the collected data.

Further embodiments of the present disclosure may include a non-transitory computer readable medium storing instructions thereon that, when executed by at least one processor cause the at least one processor to receive data collected by a first electronic sensor embedded within a first toy, a second electronic sensor embedded within a second toy, a third electronic sensor embedded within a first wearable computing device, and a fourth electronic sensor embedded within a second wearable computing device, and determine a play time, a play quality score, a play creativity score, and a peer play score responsive, at least partially, to the data collected by the first electronic sensor, the second electronic sensor, the third electronic sensor, and the fourth electronic sensor.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a block diagram depicting a system of toys, a server, and a mobile device, in accordance with one or more embodiments of the present disclosure;

FIG. 2 is a block diagram depicting a system of toys, wearable devices, a mobile device, and a server, in accordance with one or more embodiments of the present disclosure;

FIG. 3 is a flowchart depicting a method of collecting data from toys and determining various scores responsive to the collected data, in accordance with one or more embodiments of the present disclosure;

FIG. 4 is a flowchart illustration of an operation of a system for determining one or more play related scores in accordance with one or more embodiments of the present disclosure;

FIG. 5 is a flowchart depicting a method of determining movement of toys and distance between toys, in accordance with one or more embodiments of the present disclosure;

FIG. 6 is a flowchart depicting a method of determining movement of users and toys, and determining interaction between users and toys, in accordance with one or more embodiments of the present disclosure;

FIG. 7 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logic, blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

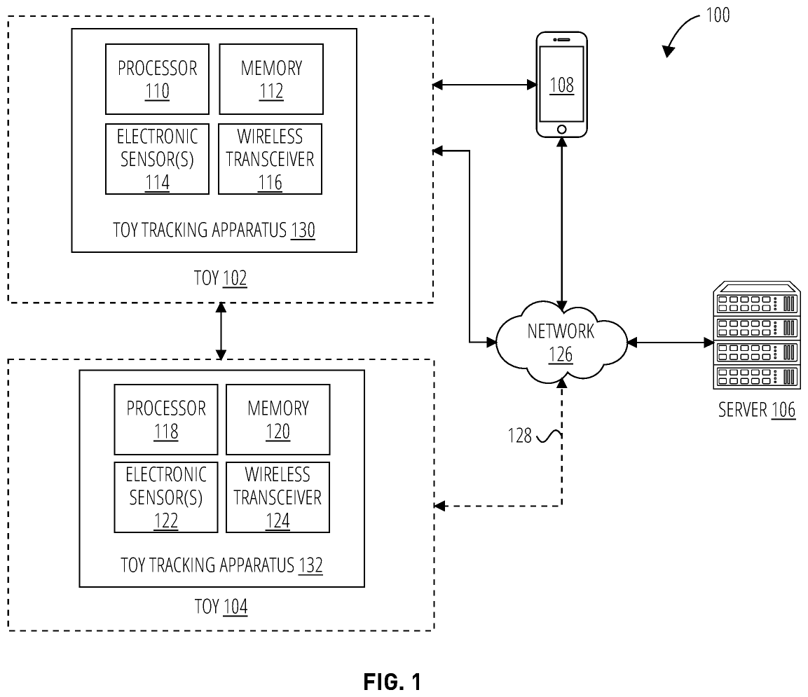

FIG. 1 is a block diagram depicting a system 100 of toys, a server, and a mobile device, in accordance with one or more embodiments. System 100 may include a first toy 102, a second toy 104, a server 106, a mobile device 108, and a network 126. Toy 102, toy 104, server 106, and mobile device 108 may communicate via network 126. Network 126 may include one or more networks, such as the Internet, and may use one or more communications platforms or technologies suitable for transmitting data and/or communication signals. Although FIG. 1 illustrates a particular arrangement of toy 102, toy 104, server 106, and mobile device 108, various additional arrangements are possible. For example, several additional toys may be a part of system 100 that are not shown in FIG. 1. In another example, toy 102 or toy 104 may communicate directly with mobile device 108, bypassing network 126.

Each of toy 102 and toy 104 may include a toy tracking apparatus 130 or toy tracking apparatus 132 where each toy tracking apparatus 130 or 132 may include a processor 110 or 118, a memory 112 or 120, one or more electronic sensors 114 or 122, and a wireless transceiver 116 or 124. In this disclosure, any reference to processor 110, memory 112, electronic sensors 114, or wireless transceiver 116 of toy 102 may also refer in a same or similar manner to processor 118, memory 120, electronic sensors 122, or wireless transceiver 124 of toy 104. Reference to the function of a toy or operations or interactions between one or more toys herein may be considered the same as a function of a toy tracking apparatus or operations or interactions between one or more toy tracking apparatuses included in the toy or toys.

Toy 102 and toy 104 may be designed to function together (i.e., be played with together). Toy 102 and toy 104 may be a same or similar kind of toy. For example, toy 102 may be a ramp, and toy 104 may be a ball designed to roll down the toy 102 ramp. In some embodiments, toy 102 and toy 104 may be different toys that are not intended or designed to function together. By way of non-limiting example, toy 102 may be a ramp that is designed to function with a ball, and toy 104 may be a building block that is designed to be used with other building blocks. Toys that are not designed to function together may be designed and programmed to communicate wirelessly with each other. As another non-limiting example, toy 102 may be the ball intended to be played with the ramp, and toy 104 may be a cup from a set of stackable cups. The toy 102 ball may be placed in a toy 104 cup, and the toy 104 cup may be stacked following the placement of the toy 102 ball. While the predetermined intention of the stackable cups is to be stacked together, and the predetermined intention of the ball is to roll down the ramp, the interaction between the toy 102 ball and the toy 104 cups may indicate a higher level of creativity. In some instances, only one toy (e.g., toy 102) is included in the system.

As illustrated in FIG. 1, toy 102 and toy 104 may each include a toy tracking apparatus 130 and toy tracking apparatus 132 respectively. Each of toy tracking apparatus 130 or 132 may be included within or on a surface of toy 102 or toy 104. For example, toy 102 may be built such that the toy tracking apparatus 130 is disposed within the toy and is not removable during normal operation of the toy 102. Additionally, in some embodiments the toy tracking apparatus 130 may be configured to be removable from toy 102. For example, the toy tracking apparatus 130 may be configured to be permanently or removably affixed to a surface or within the toy 102. In some embodiments toy tracking apparatus 130 may be configured to be toy agnostic such that the toy tracking apparatus 130 may be removed from the toy 102 and placed onto a different toy. The toy tracking apparatus 130 may also be programmable to function with any number of different kinds of toys. For example, a toy tracking apparatus 130 may include one or more toy profiles where each profile correlates to a different kind of toy. As a specific non-limiting example, in the case where toy 102 and toy 104 are in the form of a ball and a ramp, respectively, the toy tracking apparatus 130 and 132 may include corresponding “ball” and “ramp” profiles such that the toy tracking apparatus 130 and 132 are able to more easily track the interactions between the toy 102 and toy 104. For example, each profile included in the toy tracking apparatus 130 and 132 may specifically measure parameters known to be associated with certain types of play to assess whether the toy 102 and toy 104 are being operated in an expected or an intended manner. For example, in the “ball” and “ramp” example, the toy tracking apparatus 130 or 132 placed on or within the ball toy may be configured to measure parameters such as distance between the ball and the ramp, rotational velocity over time, acceleration, position and orientation with respect to the ramp, or time of play, without limitation. Toy tracking apparatus 130 and 132 may then be removed from toy 102 and toy 104 and placed onto different toys such as two separate blocks. Upon being moved to the new toys, the toy tracking apparatus 130 and 132 may be updated (e.g., by server 106 or mobile device 108) to change the profile of the toy tracking apparatus 130 to track parameters that may be associated with expected or intended interactions between two blocks. Furthermore, in some embodiments the mobile device 108 or the server 106 may send new profiles to the toy tracking apparatus 130 or toy tracking apparatus 132 or modify existing profiles via wireless communication. The toy tracking apparatus 130 and toy tracking apparatus 132 may be functionally identical and any discussion herein relating to one is relevant to the other.

In some embodiments, each profile may include one or more predetermined parameters representative of expected measurement values or ranges of values known to be associated with types of play involving the toy associated with the profile. For example, again referring to the “ball” and “ramp” example, the measurements received via the toy tracking apparatus 130 or 132 for the ball including distance between the ball and the ramp, rotational velocity over time, acceleration, position and orientation with respect to the ramp, or time of play may be compared against predetermined expected values or ranges of values included in the profile for the ball for each measured parameter value. Measured values falling within the predetermined expected ranges or within a predetermined threshold of an expected parameter value may be considered to be indicative that the manner in which the ball is being played with is “predetermined to be intended.” Conversely, if the measured values fall outside of a range of values or are outside a predetermined threshold of an expected value, the system 100 may infer that the toy was used in a manner different than those that are predetermined to be intended. In some embodiments one or more predetermined parameters representative of expected measurement values may be based, at least in part, on professional guidelines or known child milestones for assessing the development of children and associated with a pre-defined play-session Furthermore, the mobile device 108 or the server 106 may set or modify each predetermined parameter representative of expected measurement values or ranges of expected measurement values for each profile. Respective profiles may be stored in electronic format, for example, as digital information (i.e., a “digital profile”), without limitation.

Electronic sensors 114 may be configured to measure (e.g., detect, sense) movement, light, location, acceleration, orientation, force, capacitance, sound, temperature, electrical current, orientation, and/or angular velocity. For example, electronic sensors 114 may include an accelerometer or a gyroscope. Electronic sensors 114 may be configured to take a measurement at a fixed frequency (e.g., every 1 second). In some embodiments, the measurements may be taken at a higher frequency when sensor activity is detected (e.g., motion or movement is detected). In one or more embodiments, the one or more electronic sensors 114 may transmit signals indicating sensed measurements to processor 110 or other peripherals via a communication bus such as an I2C bus, for example. The sensed measurements may be stored in memory 112, either permanently or temporarily. In some instances, the sensed measurements may be interpreted to determine “movement” of toy 102.

Wireless transceiver 116 may transmit or receive wireless signals according to a predefined protocol. Examples of a protocol used to transmit and receive wireless signals may include, without limitation, Bluetooth, Bluetooth Low Energy (BLE), Zigbee, WLAN (e.g, 802.11, Wi-Fi), Z-Wave, 3G, 4G, LTE, 5G, NFC, or RFID. In one or more embodiments, wireless transceiver 116 may be configured to use more than one protocol, or in some embodiments, toy tracking apparatus 130 may include a second wireless transceiver (not shown) that is configured to communicate using a second, different wireless protocol. For example, toy tracking apparatus 130 may include wireless transceiver 116 configured to communicate with toy tracking apparatus 132 via BLE, and toy tracking apparatus 130 may also include an additional wireless transceiver configured to communicate with network 126 via Wi-Fi. In this example, toy tracking apparatus 132 may only include a single wireless transceiver 124 that is configured to communicate with toy tracking apparatus 130 via BLE and may not include an additional wireless transceiver or capability to communicate with network 126 via Wi-Fi. In this embodiment, any sensed measurements from the electronic sensor 122 of toy tracking apparatus 132 must be transmitted to toy tracking apparatus 130. The toy tracking apparatus 130 may transmit sensed measurements from both toy tracking apparatus 130 and toy tracking apparatus 132 to server 106 for analysis via network 126. In another embodiment, toy tracking apparatus 132 may include wireless transceiver 116 for BLE communication and an additional wireless transceiver (not shown) configured for Wi-Fi communication such that the sensed measurements of toy tracking apparatus 132 may be transmitted to server 106 via network 126, as shown in FIG. 1 with optional connection 128. In this embodiment, toy tracking apparatus 130 and toy tracking apparatus 132 send their own respective sensed measurements to server 106 via network 126.

Server 106 may receive data from at least one of toy tracking apparatus 130 or toy tracking apparatus 132. The received data may be based at least partially on sensed measurements from electronic sensor 114 and electronic sensor 122. Server 106 may analyze the received data to determine a play time, a play quality score, a creative play score, and a peer play score, in accordance with one or more embodiments of the present disclosure. Server 106 may provide the play time, play quality score, creative play score, and peer play score to mobile device 108, which may include an application configured to display to a user relevant metrics (e.g., the play time, play quality score, creative play score, and peer play score) related to interactions between toy 102 and toy 104. In some instances, mobile device 108 may perform computations and/or analysis that are disclosed herein as being performed by server 106.

Mobile device 108 may be a smartphone, tablet computer, PDA, or laptop. In some cases, mobile device 108 may be a desktop computer or any other kind of computing device. Mobile device 108 may include a touchscreen, keyboard, or other means of receiving input from a user. Mobile device 108 may also include a display and/or speakers to generate output messages for a user. In one or more embodiments, mobile device 108 may connect directly with toy tracking apparatus 130 via a short-range communication protocol, such as Bluetooth Low Energy (BLE) or Bluetooth, to provide provisioning data (i.e., network credentials such as network name and password) to toy tracking apparatus 130 such that toy tracking apparatus 130 may connect to a Wi-Fi network. This may be helpful because toy 102 may not have a display or a function for receiving input from a user.

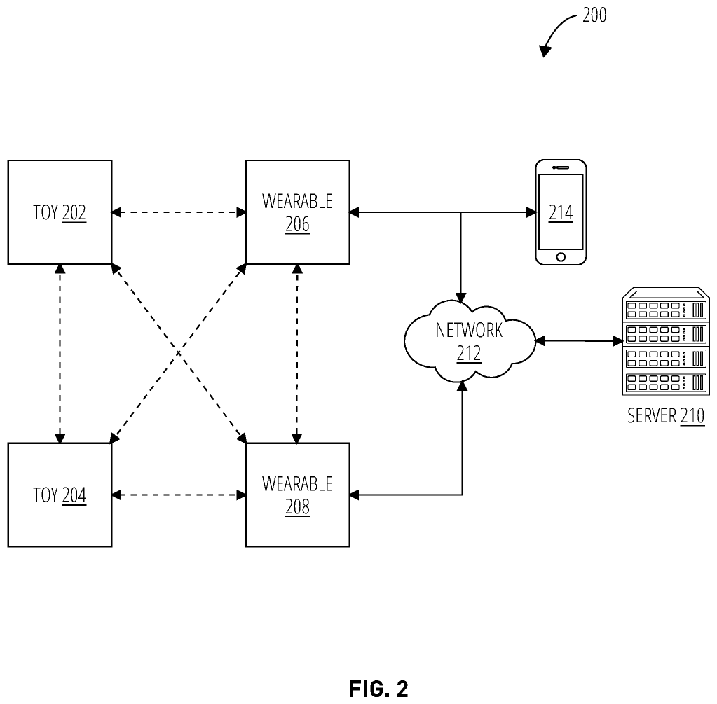

FIG. 2 is a block diagram depicting a system 200 of toys, wearable devices, a mobile device, and a server, in accordance with one or more disclosed embodiments. System 200 may include a toy 202, a toy 204, a wearable 206, a wearable 208, a server 210, a network 212, and a mobile device 214. In some embodiments, system 200 may be the same as system 100 of FIG. 1 with the addition of one or more wearable computing devices such as wearable 206 and wearable 208. For example, toy 202 and toy 204 may be examples of toy 102 and toy 104. Any discussion related to wearable 206 herein also applies to wearable 208. Although FIG. 2 illustrates a particular arrangement of toy 202, toy 204, wearable 206, wearable 208, server 210, and mobile device 214, various additional arrangements are possible. For example, additional toys or wearables may be a part of system 200 that are not shown in FIG. 2. In another example, toy 202 or toy 204 may communicate directly with mobile device 214, bypassing wearable 206 or network 126.

Although not every connection is explicitly shown, toy 202, toy 204, wearable 206, wearable 208, mobile device 214, and server 210 may all communicate via network 212. Each of toy 202, toy 204, wearable 206, and wearable 208 may communicate over an individual wireless connection with each of toy 202, toy 204, wearable 206, and wearable 208.

Wearable 206 and wearable 208 may each be a computing device that is worn or attached to a user's body. Similar to toys 102 and 104, wearables 206 and 208 may include one or more processors, memory, wireless transceivers, and electronic sensors. Wearable 206 and wearable 208 may each be a wristband, a smartwatch, a clip, smart clothing (e.g., a smart sock), headphones, a smart ring, glasses, or an activity tracker. Wearables 206 and 208 may have names and information regarding a wearer stored in memory. Wearables 206 and 208 may track movement and/or vital signs of a wearer (e.g., user of a wearable or individual who is wearing or has a wearable attached to the body) along with ambient data. Movement of the wearer may be tracked by sensing acceleration, orientation, and angular velocity. This sensed data may be interpreted by the one or more processors included in the wearable to determine how fast and in which direction the wearer is moving, or the raw movement data may be transmitted to server 210 for analysis, interpretation, and processing. Wearables 206 and 208 may also measure a signal strength of any wireless communication connection signal between wearables 206 and 208 and one or more of the different connected elements of system 100. Wearables 206 and 208 may transmit movement data, vital signs data, ambient data, and signal strength of the wearer to server 210 or to mobile device 214.

Server 210 may determine a physical interaction of a wearer of wearable 206 or wearable 208 with toy 202 or toy 204. Physical interaction may be determined based on movement of the wearer of the wearable 206, the movement and sensed measurements of toy 202 and/or toy 204 and a measured signal strength between wearables 206 and 208 and toys 202 and 204. A signal strength of a wireless connection may be used to determine a distance between the two connected elements. For example, a high signal strength between wearable 206 and toy 102 may indicate that wearable 206 and toy 102 are close, while a low signal strength may indicate that wearable 206 and toy 102 are far away from each other. By way of non-limiting example, if a movement of wearable 206 corresponds to (e.g., is similar in direction and speed) a movement of toy 202, and the signal strength is very high, server 210 may determine that the wearer of wearable 206 is holding toy 202.

In some embodiments, system 200 only includes one wearable 206 as there may be only one user playing with toy 202 and toy 204. In other embodiments, system 200 includes one or more additional wearables, such as wearable 208. Wearable 208 may perform some or all of the same functions as wearable 206 such as tracking movement of a wearer (e.g., user) of wearable 208, which may be a different person than a wearer of wearable 206. Wearable 208 may transmit movement data to server 210 or to mobile device 214 for analysis. In some embodiments, wearable 208 does not have a direct connection to the network 212 and instead transmits the movement data to wearable 206, which relays (e.g., forwards) the movement data of wearable 208 to network 212 or mobile device 214.

Server 210 may determine a physical interaction of a wearer of wearable 206 and of a wearer of wearable 208. The physical interaction may be based on the movement data of the wearable 206 and of the wearable 208. Server 210 may determine a peer play score based on the determined physical interaction of the wearer of wearable 206 and the wearer of wearable 208. The peer play score may also be further based on the movement data of toy 202 and toy 204 and any determined physical interaction between the wearables 206 and 208 and toys 202 and 204. The peer play score may be a score indicative of coordinated interaction between two users (e.g., wearers of wearables 206 and 208). By way of non-limiting example, a first user may move toy 202 in a particular manner. A second user may copy (e.g., mimic) the movement of the first user and move toy 204 in the same or similar particular manner. Another example may include two users respectively moving toys 202 and 204 in a coordinated or synchronous manner. Another example may be that server 210 may determine that a user shares his or her toy in a productive manner. A peer play score may be lowered if there is any behavior or movement from a user that is predetermined to be undesired. For example, one user may strike or push the other, with or without a toy, resulting in a lower peer play score. The peer play score may be a function of solo play time (e.g., time spent playing without any other users) and group play time (e.g., time spent playing with one or more other users), and distance between users during play time. A closer distance may indicate increased collaboration during play time and may result in an increase to the peer play score for a particular user. The peer play score may also be based on how many other users interact with the user receiving the peer play score.

Server 210 may determine which toy (e.g., toy 202 or toy 204) a wearer of wearable 206 is playing with based on the movement data associated with wearable 206 and sensed measurements of toy 202 or toy 204.

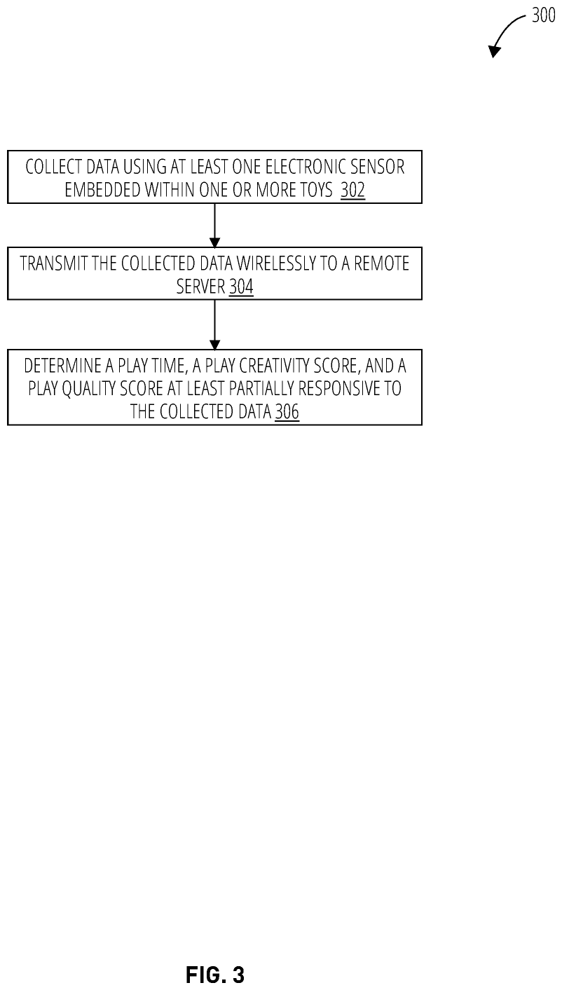

FIG. 3 is a flowchart depicting a method 300 of collecting data from toys and determining various scores responsive to the collected data, in accordance with one or more embodiments of the present disclosure. Method 300 may be performed, as non-limiting examples, by system 100 of FIG. 1 or system 200 of FIG. 2. Although illustrated as discrete blocks, various blocks may be divided into additional blocks, combined into fewer blocks, or eliminated, depending on the desired implementation.

At operation 302, method 300 collects data using at least one electronic sensor embedded within one or more toys. Collecting data may include taking sensed measurements from the at least one electronic sensor embedded within the one or more toys. The sensed measurements may be taken on a fixed frequency or may be taken at random intervals.

At operation 304, method 300 transmits the collected data wirelessly to a remote server. The data may be transmitted to the remote server via a network. For example, the one or more toys may transmit the sensed measurements data wirelessly to a mobile device which may then relay the sensed measurements data to the remote server via the Internet. Alternatively, the one or more toys may be directly connected to a Wi-Fi network which is connected to the Internet.

At operation 306, method 300 determines a play time, a play creativity score, and a play quality score at least partially responsive to the collected data. The play time may refer to any time where the one or more toys is moving, being touched, or interacted with. The one or more toys may include a circuitry that has a play time counter that detects movement and tracks the amount of time that the one or more toys is moving. In some embodiments, a movement time is added to the play time counter only if the movement is determined to be “play” and not just periodic or random movement. For example, there may be a threshold amount of time for a movement that may be considered “play” while any movement that occurs below the threshold amount of time is not considered “play.” This may occur, for example, as the one or more toys are bumped or put away. Furthermore, movements that are predetermined to be patterns of play may be stored in the remote server. Sensed measurements data from the electronic sensor in the one or more toys may be transmitted to the server and compared to the predetermined patterns of play to determine whether the determined movement is “play.” If the determined movement is similar to the predetermined patterns of play, then the time during the movement may be added to the play time. Another factor in determining play time may be a distance between toys in a system of toys. If the toys are close together while moving, then it may be determined that the toys are being played with, while if the toys are far apart, then play time may not be counted. Distance between toys may be determined based in different ways, including signal strength of a wireless connection between the toys.

A play creativity score may include a determination that the one or more toys are used in a manner that is different than predetermined to be intended. For example, certain systems of toys are designed to be played with in a particular, predetermined manner. By way of non-limiting example, a predetermined intention of stackable cups may be to fit together compactly or be stacked on top of each other. However, children may use stackable cups to turn them over and hide things (i.e., other unrelated toys) underneath, which may be considered a manner that is different than what is predetermined to be intended for the stackable cups. Furthermore, the play creativity score may be dependent on a child combining toys from one set of toys with a toy from a different set of toys, where it is not predetermined to be intended that the child plays with a toys from the different sets of toys.

A play quality score comprises a determination that the one or more toys are used as predetermined to be intended. Following the above non-limiting example of stackable cups, a user may receive a higher score if the stackable cups are interacted with (e.g., played with) in one of the manners that is predetermined as to be intended (e.g., fitting the toys compactly together or stacking them on top of each other). In some embodiments, the play quality score may be higher if the user completes a particular task quickly. In other words, the faster that a user puts the cups together or stacks them, the higher the play quality score.

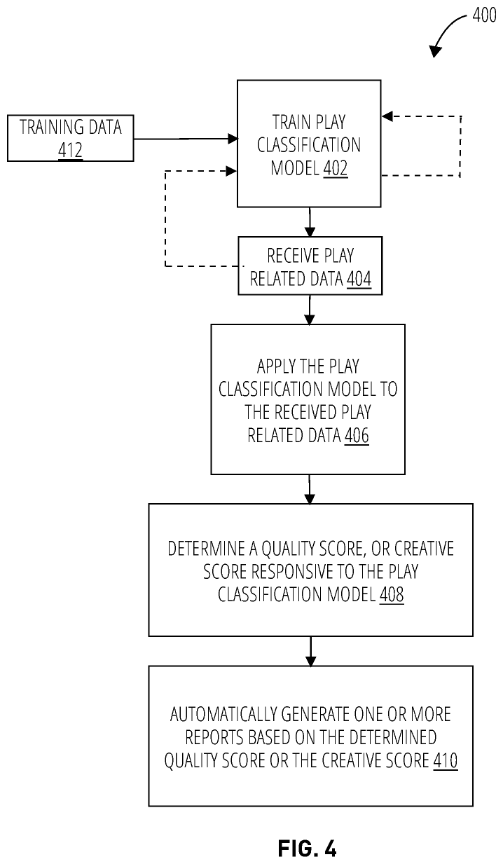

In some embodiments, one or more play related scores (e.g., the play creativity or play quality scores) may be determined via a machine learning model, as shown in FIG. 4. FIG. 4 is a flowchart depicting a method 400 of an operation of a system (e.g., system 100 or system 200) performed by a processor executing instructions stored on a computer-readable medium. For case of description, the method 400 will discuss an operation for system 200, though any of the operations of method 400 may illustrate an operation of the system 100 as well. Method 400 illustrates operations of system 200 for determining a quality play score, or creative play score responsive to one or more machine learning techniques. As used herein “classification model” may refer to a trained learning model for classifying a play session with a quality and or creativity score.

At operation 402, the system 200 trains a play classification model for determining one or more scores relating to the quality or creativity represented in the play session. For example, the play classification model may take as input the training data 412. The training data 412 may include training parameters relating to a pre-defined play session. Each pre-defined play session may be associated with one or more training parameters including movement, light, location, acceleration, orientation, force, capacitance, sound, temperature, electrical current, and/or angular velocity values. For example, the training parameters may include one or more parameters from a toy (e.g., toy 102 or toy 104) or a wearable (e.g., wearable 206 or wearable 208). The training data may also include data relating to one or more predetermined quality scores, creativity scores, or other scores associated with one or more of the play sessions represented in the training data. For example, the predetermined quality or creativity scores may be based, at least in part, on data derived from professional guidelines or known child milestones for assessing the development of children and associated with a pre-defined play-session. Furthermore, in some embodiments, the predetermined quality or creativity scores may be manually assessed based on previously recorded measurements involving the one or more toys or wearables for a previously detected play session. In any case, each play session represented in the training data may have an associated predetermined score (e.g., a quality or creativity score) indicative of one or more attributes of the play session.

The training parameters for each play session may then be used as input to a play classification model configured to classify each play session as having an associated play score (e.g., a quality and/or creativity score) based on the input parameters associated with each play session. For example, for each defined play session, the various training parameters of the play session may be associated with a certain level of overall creativity and/or quality of play involving one or more participants in the play session. For instance, the play classification model may associate the parameters of a play session with a creativity or quality score on a predetermined scale (e.g., 1-10) so that each play session may be easily assessed and compared to other play sessions such as, for example, a baseline play session to track and measure the physical, spatial, social, or cognitive development of a child.

The play classification model may then classify each play session as having one or more scores (e.g., a quality or creativity score) based on the training parameters for each play session. Each play session and its associated quality or creativity scores determined by the play classification model may then be compared to the predetermined quality or creativity scores associated with each play session to determine whether the play classification model properly classified each play session. For example, a “closeness” score may be generated responsive to the comparison between the quality and/or creativity scores of the play sessions determined by the play classification model and the predetermined quality and/or creativity scores associated with each play session. Where the closeness score is a measure of how close the scores determined by the play classification model are to the predetermined scores associated with each play session.

If the generated closeness score is outside of a predetermined acceptable threshold, the play classification model may automatically change one or more parameters of the model (e.g., one or more parameters of one or more nodes of a Convolutional Neural Network (CNN)) and the process may be repeated until the closeness score is within the predetermined acceptable threshold. In other words, via machine learning techniques, the play classification model may learn correlations between the input parameters (e.g., measured data from toys or wearables) and one or more scores based on those parameters. For example, the play classification may learn to classify a play session where there is little to no interaction between the toys or wearables represented in the input parameters as having both a low quality score as well as a low creativity score.

Though discussed primarily as having a creativity score and a quality score, the play classification model may be trained to classify a play session to have any number of associated scores. For example, a play session may also be classified as having a peer play score indicative of how well one or more individuals (e.g., children) interacted with others during a play session.

With regard to the play classification model, in some embodiments the play classification model may be in the form of an encoder-decoder model that accepts the data (e.g., play session data) as input and extracts one or more feature vectors from the input data. For example, the play classification model may encode the input data to a latent space representation of the input data. In some embodiments, the encoder may be in the form of an auto-encoder configured to automatically extract one or more features from the input data. The decoder may then decode the feature vectors or the latent space representation of the input to classify one or more play sessions represented in the input data based on the extracted feature vectors. Though discussed in terms of an encoder-decoder model, any machine learning technique may be used so long as the technique may classify one or more play sessions based on data associated with each play session. For example, classification may be accomplished though machine learning techniques such as logistic regression, quadratic regression analysis, decision trees, regression trees, boosted trees, gradient boosted trees, multilayer perceptron, one-vs-rest, random forest, support vector machines, K nearest neighbor, or Naïve Bayes, association rule learning, a neural network, deep learning, pattern recognition, or any other type of machine learning without limitation.

In operation 404, the system 200 receives play related data. For example, referring to both FIG. 2 and FIG. 4 together, the system 200 may receive one or more measurements (e.g., sensed measurements) from one or more toys (e.g., toy 202 or toy 204) or wearables (e.g., wearable 206 or wearable 208). The system 200 may then determine one or more play sessions responsive to the one or more measurements, each play session associated with one or more of the one or more measurements. In some embodiments, the received play related data may include validation data used to validate the trained classification model. For instance, the validation data may include one or more data sets including play sessions and associated predetermined quality and/or creativity scores for each play session where the validation data may be different from the data used to train the play classification model. If, based on the validation data, it is determined that the play classification model does not produce closeness scores within a predetermined threshold, additional training data may be received and used to further train the classification model.

At operation 406, the system 200 applies the trained play classification model to the received one or more measurements (e.g., measurements associated with one or more play sessions) included in the received play related data. For example, the classification model may be applied to measurements received from toys 202 and 204 as well as wearables 206 and 208 that are received in real time. At operation 408, the system 200 may then, responsive to applying the classification model to the one or more measurements, determine a quality and/or creativity score for each play session represented in the measured data. As a specific example, a play session may be classified as having a quality score of 6 (on a 1-10 scale) and a creativity score as a 9 (also on a 1-10 scale). Though discussed as being measured along similar scales, the quality score and the creativity score may be defined using different scales. Furthermore, a play session may be classified as having one or more additional score types. For example, a play session may be classified as having a peer-play score that indicates, based on the input one or more measurements, how well one or more individuals (e.g., children) involved in a play session interacted with one another.

At operation 408, the system 200 automatically generates one or more reports based on the determined quality or creative score associated with one or more play sessions. For example, the system 200 may generate one or more reports with information intended for parents, teachers, or healthcare providers to provide one or more insights based on the quality, creativity, or other scores associated with play sessions of a particular child. For example, the one or more reports may provide one or more insights involving the motor, spatial, social, or cognitive development of an individual (e.g., a child). The one or more reports may also include one or more recommendations based on the quality or creativity scores. For example, the reports may recommend that a child be instructed to perform particular forms of play involving toys 202 and 204 or to avoid certain types of play with other children.

In some embodiments, the system 200 may provide one or more alerts responsive to applying the play classification model to measured data from toys 202 and toy 204 or wearables 206 and 208 in real time. For example, real-time data input into the model may indicate that a participant in a play session (e.g., a child) is acting violently toward other individuals (e.g., other children) participating in the play session. Upon detection of violent acts, an alert may be produced and provided to a user via a display of mobile device 214. Additionally, in some embodiments the system 200 may provide one or more recommendations to mobile device 214 responsive to applying the play classification model to measured data from toys 202 and 204 or wearables 206 and 208 in real time. For example, responsive to classification of real time input data, the system 200 may provide one or more recommendations to mobile device 214 to help to improve the quality, creativity, or some other aspect of a play session that an individual (e.g., a child) is currently engaging in that is represented in the real time input data.

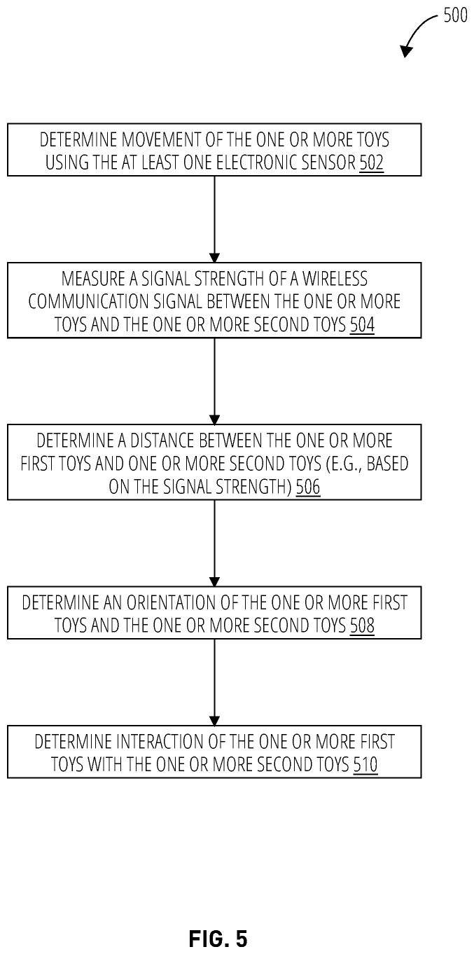

FIG. 5 is a flowchart depicting a method 500 of determining movement of toys and distance between toys, in accordance with one or more embodiments of the present disclosure. In operation 502, the method 500 determines movement of one or more toys using at least one electronic sensor. For example, an electronic sensor included in a toy may be in the form of a gyroscope or accelerometer configured to capture and record movement vectors and rotational orientation data and rotational acceleration data. In operation 504, the method 500 measures a signal strength of a wireless communication signal between one or more first toys and one or more second toys.

At operation 506, the Method 500 determines a distance between the one or more first toys and the one or more second toys. For example, the distance between the one or more first toys and the one or more second toys may be determined responsive to the measured signal strength of a wireless communication signal between the one or more first toys and the one or more second toys. Furthermore, the signal strength (and thereby the distance) between the one or more toys and the second one or more toys may be measured over time to determine movement data of the one or more first toys and the one or more second toys. At operation 508, the method 500 determines an orientation of the one or more first toys and the one or more second toys (e.g., via a gyroscope included in one or more of the one or more first toys and the one or more second toys).

At operation 510, the method 500 determines an interaction of the one or more first toys with the one or more second toys. For example, an interaction may be defined by the detected movement or orientation data associated with each of the one or more first toys and each of the one or more second toys. The movement or orientation data of the one or more first toys and the one or more second toys may be measured over time to determine how each of the one or more first toys and the one or more second toys were positioned relative to each other over time to determine how the one or more first toys interacted with each other. For example, an interaction may include an event where the one or more first toys and the one or more second toys are initially positioned away from each other and then rapidly moved closer to each other until coming to an abrupt stop when the distance between the one or more first toys or one or more second toys is substantially zero indicating that the one or more first toys and the one or more second toys collided with each other. Furthermore, the orientation and position data may indicate a direction of movement, orientation, or angle of each toy involved in the collision event.

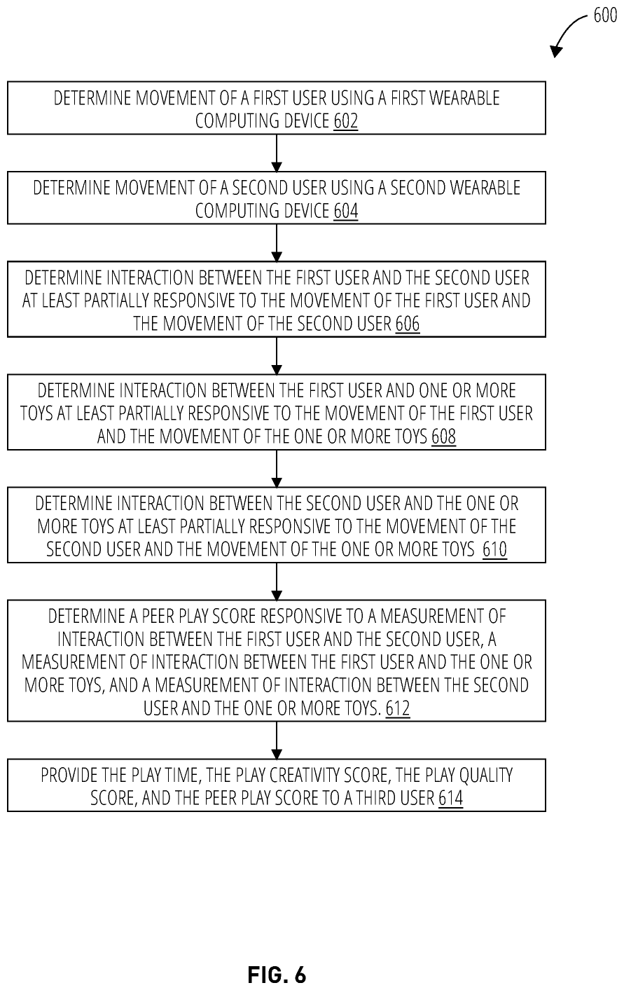

FIG. 6 is a flowchart depicting a method 600 of determining movement of users and toys, and determining interaction between users and toys, in accordance with one or more embodiments of the present disclosure.

In operation 602, method 600 determines movement of a first user using a first wearable computing device. In operation 604, method 600 determines movement of a second user using a second wearable computing device. In operation 606, method 600 determines interaction between the first user and the second user at least partially responsive to the movement of the first user and the movement of the second user. In operation 608, method 600 determines interaction between the first user and the one or more toys at least partially responsive to the movement of the first user and the movement of the one or more toys. In operation 610, method 600 determines interaction between the second user and the one or more toys at least partially responsive to the movement of the second user and the movement of the one or more toys. In operation 612, method 600 determines a peer play score responsive to a measurement of interaction between the first user and the second user, a measurement of interaction between the first user and the one or more toys, and a measurement of interaction between the second user and the one or more toys.

In operation 614, method 600 provides the play time, the play creativity score, the play quality score, and the peer play score to a third user. In some embodiments, the play time, play creativity score, the play quality score, and the peer play score may be provided to a mobile device which may display the scores. In some embodiments, the scores may be displayed with analysis as to what the scores mean and how they are relevant to the first and/or second user's development. For example, the scores may be display in conjunction with one or more generated reports for use by a parent, teacher, or healthcare provider. The scores may also include recommendations for the third user to implement in order to help the first and second user to develop in different ways. As a specific non-limiting example, the method 600 may include generating one or more reports based on the play time, play creativity score, play quality score and the peer play score that provides insights into the development of the first or second users based on the play time, play creativity score, play quality score, and peer play score. The generated report may then be provided to a third user via a display of the mobile device.

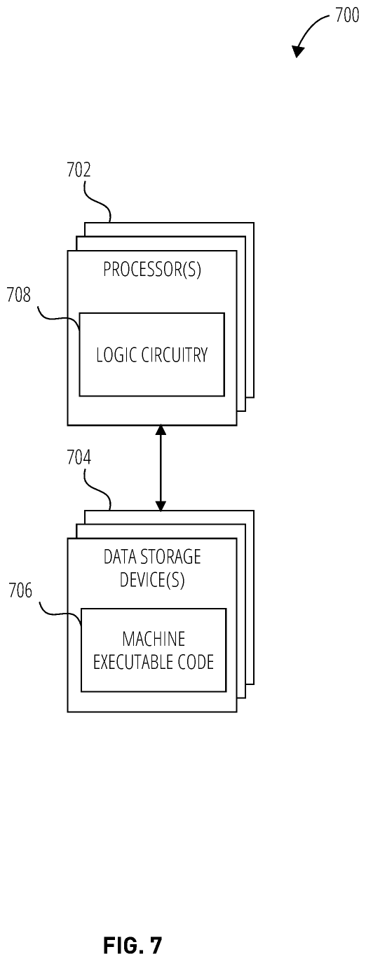

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 7 illustrates non-limiting examples of implementations of functional elements disclosed herein. In some embodiments, some or all portions of the functional elements disclosed herein may be performed by hardware specially configured for carrying out the functional elements.

FIG. 7 is a block diagram of circuitry 700 that, in some embodiments, may be used to implement various functions, operations, acts, processes, and/or methods disclosed herein. The circuitry 700 includes one or more processors 702 (sometimes referred to herein as “processors 702”) operably coupled to one or more data storage devices (sometimes referred to herein as “storage 704”). The storage 704 includes machine executable code 706 stored thereon and the processors 702 include logic circuitry 708. The machine executable code 706 includes information describing functional elements that may be implemented by (e.g., performed by) the logic circuitry 708. The logic circuitry 708 is adapted to implement (e.g., perform) the functional elements described by the machine executable code 706. The circuitry 700, when executing the functional elements described by the machine executable code 706, should be considered as special purpose hardware configured for carrying out functional elements disclosed herein. In some embodiments the processors 702 may be configured to perform the functional elements described by the machine executable code 706 sequentially, concurrently (e.g., on one or more different hardware platforms), or in one or more parallel process streams.

When implemented by logic circuitry 708 of the processors 702, the machine executable code 706 is configured to adapt the processors 702 to perform operations of embodiments disclosed herein. For example, the machine executable code 706 may be configured to adapt the processors 702 to perform at least a portion or a totality of the method 300 of collecting data from toys and determining various scores, method 500 of determining movement of toys and distance between toys, and method 600 of determining movement of users and toys, and determining interaction between users and toys. As another example, machine-executable machine executable code 706 may adapt processors 702 to perform at least a portion or a totality of the operations discussed for toys 102 and 104, mobile device 108, server 106 of FIG. 1, and toys toy 202 and 204, wearables 206 and 208, mobile device 214, and server 210 of FIG. 2.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 706 (e.g., software code, firmware code, hardware descriptions) related to embodiments of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some embodiments the storage 704 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 702 and the storage 704 may be implemented into a single device (e.g., a semiconductor device product, a system on chip (SOC), etc.). In some embodiments the processors 702 and the storage 704 may be implemented into separate devices.

In some embodiments the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuitry 708. Also by way of non-limiting example, the computer-readable instructions may be stored on the storage 704, transferred to a memory device (not shown) for execution, and executed by the processors 702 using at least the logic circuitry 708. Accordingly, in some embodiments the logic circuitry 708 includes electrically configurable logic circuitry 708.

In some embodiments the machine executable code 706 may describe hardware (e.g., circuitry) to be implemented in the logic circuitry 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine executable code 706 may include an HDL, an RTL, a GL description, a mask level description, other hardware description, or any combination thereof.

In embodiments where the machine executable code 706 includes a hardware description (at any level of abstraction), a system (not shown, but including the storage 704) may be configured to implement the hardware description described by the machine executable code 706. By way of non-limiting example, the processors 702 may include a programmable logic device (e.g., an FPGA or a PLC) and the logic circuitry 708 may be electrically controlled to implement circuitry corresponding to the hardware description into the logic circuitry 708. Also by way of non-limiting example, the logic circuitry 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuitry 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present disclosure is not so limited. Rather, many additions, deletions, and modifications to the illustrated and described embodiments may be made without departing from the scope of the disclosure as hereinafter claimed along with their legal equivalents. In addition, features from one embodiment may be combined with features of another embodiment while still being encompassed within the scope of the disclosure as contemplated by the inventor.

What is claimed is:

1. A system, comprising:
a first toy tracking apparatus and a second toy tracking apparatus, each of the first toy tracking apparatus and the second toy tracking apparatus comprising:
at least one processor;
at least one memory;
at least one electronic sensor; and
a wireless transceiver; and
a server configured to:
receive data from at least one of the first toy tracking apparatus or the second toy tracking apparatus, the data based at least partially on sensed measurements by the at least one electronic sensor of at least one of the first toy tracking apparatus or the second toy tracking apparatus;
determine a play time, a play quality score, and a creative play score at least partially responsive to the received data; and
generate one or more reports based, at least partially, on the determined play time, play quality score, and creative play score.

2. The system of claim 1, the server further configured to:
train a play classification model configured to classify play related data;
apply the play classification model to the received data to determine the play quality score, the creative play score, or the peer-play score for the received data;

3. The system of claim 1, further comprising a first wearable computing device configured to:
track movement of a first user that is playing with a first toy including the first toy tracking apparatus or a second toy including the second toy tracking apparatus; and
wirelessly transmit movement data of the first wearable computing device to the server.

4. The system of claim 3, wherein the server is further configured to determine a physical interaction of the first user with the first toy or the second toy responsive to the movement data of the first wearable computing device and the sensed measurements of the first toy or the second toy.

5. The system of claim 3, further comprising a second wearable computing device configured to:
track movement of a second user that is playing with the first toy or the second toy; and
wirelessly transmit movement data of the second wearable computing device to the server.

6. The system of claim 5, wherein the server is further configured to:
determine a physical interaction of the second user with the first toy or the second toy responsive to the movement data of the second wearable computing device and the sensed measurements of the first toy or the second toy;
determine a physical interaction of the first user with the second user responsive to the movement data of the first wearable computing device and the movement data of the second wearable computing device.

7. The system of claim 6, wherein the server is configured to determine a peer play score responsive to the physical interaction of the first user with the second user.

8. The system of claim 1, wherein the at least one electronic sensor of the first toy tracking apparatus and the second toy tracking apparatus is configured to measure one or more of movement, light, location, acceleration, orientation, force, capacitance, sound, temperature, electrical current, and angular velocity.

9. A method, comprising:
collecting data using at least one electronic sensor embedded within one or more toys;
transmitting the collected data wirelessly to a remote server; and
determining a play time, a play creativity score, and a play quality score at least partially responsive to the collected data.

10. The method of claim 9, further comprising:
determining movement of the one or more toys using the at least one electronic sensor;
determining interaction of the one or more toys with one or more second toys, wherein determining interaction comprises:
determining a distance between the one or more first toys and the one or more second toys; and
determining an orientation of the one or more first toys and the one or more second toys.

11. The method of claim 9, wherein the play time comprises a determined amount of time that a user interacts with the one or more toys.

12. The method of claim 9, wherein the play creativity score comprises a determination that the one or more toys are used in a manner that is different than predetermined to be intended and the play quality score comprises a determination that the one or more toys are used as predetermined to be intended.

13. The method of claim 10, wherein determining a distance between the one or more toys and the one or more second toys comprises:
measuring a signal strength of a wireless communication signal between the one or more toys and the one or more second toys; and
determining the distance between the one or more toys and the one or more second toys based on the signal strength.

14. The method of claim 10, further comprising:
determining movement of a first user using a first wearable computing device;
determining movement of a second user using a second wearable computing device;
determining interaction between the first user and the second user at least partially responsive to the movement of the first user and the movement of the second user;
determining interaction between the first user and the one or more toys at least partially responsive to the movement of the first user and the movement of the one or more toys;
determining interaction between the second user and the one or more toys at least partially responsive to the movement of the second user and the movement of the one or more toys.

15. The method of claim 14, further comprising:
determining a peer play score responsive to a measurement of interaction between the first user and the second user, a measurement of interaction between the first user and the one or more toys, and a measurement of interaction between the second user and the one or more toys.

16. The method of claim 14, wherein determining interaction between the first user and the second user comprises:
determining a distance between the first user and the second user; and
determining an orientation of the first wearable computing device and an orientation of the second wearable computing device.

17. The method of claim 16, wherein determining a distance between the first user and the second user comprises measuring a signal strength of a wireless communication signal between the first user and the second user.

18. The method of claim 15, further comprising providing the generated report to a third user.

19. A non-transitory computer-readable medium storing instructions thereon that, when executed by at least one processor, cause the at least one processor to perform steps comprising:
receive data collected by a first electronic sensor embedded within a first toy, a second electronic sensor embedded within a second toy, a third electronic sensor embedded within a first wearable computing device, and a fourth electronic sensor embedded within a second wearable computing device;
determine a play time, a play quality score, a play creativity score, and a peer play score responsive at least partially to the data collected by the first electronic sensor, the second electronic sensor, the third electronic sensor, and the fourth electronic sensor.

20. The non-transitory computer-readable medium of claim 19, storing further instructions that, when executed by at least one processor, cause the at least one processor to perform further steps comprising:
providing the play time, the play quality score, the play creativity score, and the peer play score for display on a device.
